(19) United States
(12) Patent Application Publication
(10) Pub. No.: US 2024/0010516 A1
(43) Pub. Date: Jan. 11, 2024

(54) Valorization of Waste Streams

(71) Applicant: LIXIVIA, INC., Santa Barbara, CA (US)

(72) Inventor: Michael D Wyrsta, Santa Barbara, CA (US)

(21) Appl. No.: 18/025,278

(22) PCT Filed: Sep. 10, 2021
(86) PCT No.: PCT/US2021/049817

§ 371 Date: Mar. 8, 2023

Related U.S. Application Data
(60) Provisional application No. 63/077,296, filed on Sep. 11, 2020.

(51) Int. Cl. C01G 49/02; C01F 11/28; C01F 11/32; B01J 20/06; B01J 20/30; B01D 53/48; B01D 53/81

(52) U.S. Cl. CPC C01G 49/02; C01F 11/28; C01F 11/32; B01J 20/06; B01J 20/3085; B01D 53/48; B01D 53/81; B01D 2257/30; B01D 2257/60; B01D 2256/245; B01D 2258/05; B01D 2253/1124

(57) ABSTRACT

Methods for utilizing waste products of the steel industry are provided that utilize spent pickle liquor to recover valuable alkaline earth metals from low value wastes with significant calcium content in the form of insoluble oxide, hydroxides, and/or salts are provided, as well as methods for generating a ferric oxide hydroxide composite from steel slag. Suitable raw materials include slag from steel manufacturing and ash from various operations. Ferric oxide hydroxide composite materials described herein can be used for removal of sulfur and metals from contaminated materials. Accordingly, compositions and methods of the inventive concept introduce considerable value to low value waste materials that would otherwise be discarded. In addition, compositions and methods of the inventive concept serve to reduce waste streams from industrial processes.

This application claims the benefit of U.S. Provisional Patent Application Ser. No. 63/077,296 filed on Sep. 11, 2020. These and all other referenced extrinsic materials are incorporated herein by reference in their entirety. Where a definition or use of a term in a reference that is incorporated by reference is inconsistent or contrary to the definition of that term provided herein, the definition of that term provided herein is deemed to be controlling.

This invention was made with government support under (>>>identify the contract<<<) awarded by (>>>identify the Federal agency<<<). The government has certain rights in the invention.

### FIELD OF THE INVENTION

The field of the invention is metal recovery, in particular from industrial waste.

### BACKGROUND

Steel production and processing generates large volumes of waste products. One of the major waste streams is slag, in its various forms (Basic Oxygen Furnace or BOF slag, Ladle Metallurgy Facility or LMF slag, desulphurized slag or Desulph, Dephosphorization slag or Dephos, etc.). Approximately 300 kgs of steel slag are produced for every ton of raw steel made. Although generally considered non-hazardous, this material represents a waste stream of considerable volume from a common large-scale process.

Another waste product of steel processing is a result of the “pickling” process, which involves chemical dissolution of surface impurities from the processed steel. Pickling is performed using a variety of acidic preparations, all of which form soluble salts with the components of surface impurities commonly found on steel (such as iron oxide). Typical pickling compositions include hydrochloric acid, nitric acid, sulfuric acid, and some organic acids. The resulting spent pickle liquors are often considered toxic or hazardous. The scale of spent pickle liquor production is also considerable, with China alone producing in excess of 10⁶ cubic meters of spent pickle liquor annually.

Currently the most common method for treatment of spent pickle liquors is simple neutralization, typically with lime, followed by disposal. Unfortunately, this disposal is often into local bodies of water, where it introduces considerable metal contamination. U.S. Pat. No. 2,746,920 (to Wunderley) describes the use of blast furnace slag to neutralize spent pickle liquor, however large amounts of slag are required. All publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Jianzhao Tang et al. (Procedia Environmental Sciences 31:778-784 (2016)) discusses a process in which iron is recovered from spent pickle liquor from steel making processes by adding ammonia or ammonium salts to generate Fe(OH)₂, from which iron oxide can be generated by calcination and recovered as a source of iron. Ammonia, however, is volatile and the large amounts of ammonia utilized would require implementation of environmental controls.

Thus, there is still a need for a safe, economical, and environmentally conscious method for treating waste products of metal processing.

### SUMMARY OF THE INVENTION

The inventive subject matter provides apparatus, systems and methods in which spent pickle liquor is used to recover alkaline earth metals (such as calcium) from low value waste materials (e.g., steel slag).

Embodiments of the inventive concept include methods for extracting calcium from a solid source material (e.g., steel slag or ash) by obtaining a spent pickle liquor and contacting the solid source material with the spent pickle liquor, in the absence of a lixiviant. This generates an aqueous solution that includes Ca(Cl)₂, a solid that includes Fe(OH)₂, and an extracted source material. In some embodiments the spent pickle liquor is contacted with metallic iron prior to or simultaneously with contacting the solid source material. In other embodiments metallic iron is present in the solid source material. HCl content of the spent pickle liquor can be less than about 10%. In some embodiments the aqueous solution is separated from the solid comprising Fe(OH)₂ and from the extracted source material. In some embodiments the solid containing Fe(OH)₂ is separated from the extracted source material. Such separations can be accomplished by any suitable method, for example filtration, decanting, settling, and/or centrifugation. In some embodiments the extracted source material is further processed to extract an additional metal.

Another embodiment of the inventive concept is a method of preparing a composite material by preparing a suspension of slag (e.g., a steel slag) in an aqueous medium, then adjusting pH of the slag suspension to 2 or less (e.g. by the addition of an acid and/or spent pickle liquor) to form an acid suspension and mixing for from 2 to 8 hours. The pH of the acid suspension then adjusted to between 9 to 12 (e.g., by the addition of lime or other carbonate-containing material) to form a basic suspension and mixing for from 30 minutes to 2 hours. The resulting materials is then oxidized by adding an oxidant (e.g. air, an oxygen-containing gas, a peroxide compound, etc.) to the basic suspension and mixing to generate a composite material that includes ferric oxide hydroxide. In some embodiments the composite material can be further processed by separating the composite from the liquid phase to generate a particulate solid comprising the composite; followed by drying the particulate solid.

Another embodiment of the inventive concept is a ferric oxide hydroxide composite material produced as described above.

Other embodiments of the inventive concept include methods for removing sulfur or a sulfur-containing compound from a fluid (e.g., natural gas, natural gas liquids, biogas, landfill gas, acid gas, geothermal gas, tank vent gas, coke oven gas, and/or oilfield associated gas) by contacting the fluid with a ferric oxide hydroxide composite material as described above for a period of time sufficient for sulfur or the sulfur-containing compound to complex with the ferric oxide hydroxide composite material.

Other embodiments of the inventive concepts include methods for removing a metal (e.g. selenium, arsenic, and/or a heavy metal) from a material contaminated with the metal by contacting the material with a ferric oxide hydroxide composite material of as described above for a period of time sufficient for the metal to complex with the ferric oxide hydroxide composite material.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 schematically depicts a typical process for generating a ferrous oxide hydroxide composite material from steel slag

FIG. 2 shows typical ICPMS data for solutions in Example 1.

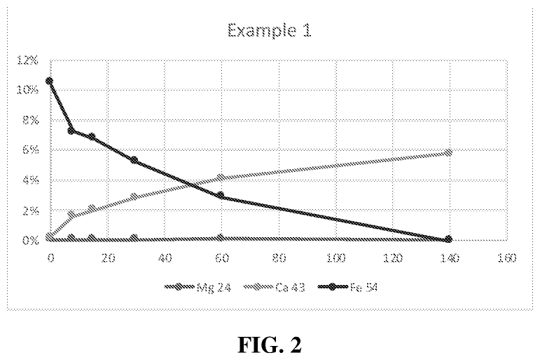

FIG. 3 shows typical ICPMS data for solids in Example 1.

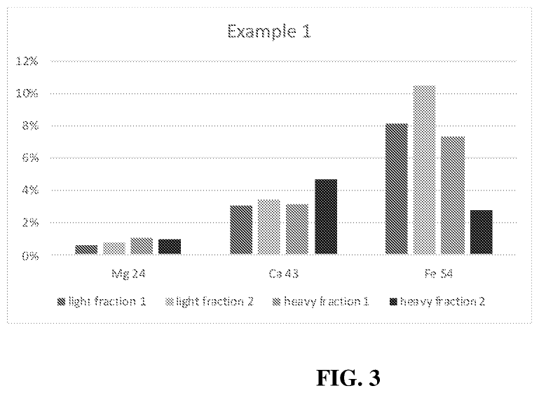

FIG. 4 shows typical ICPMS data for solutions in Example 2.

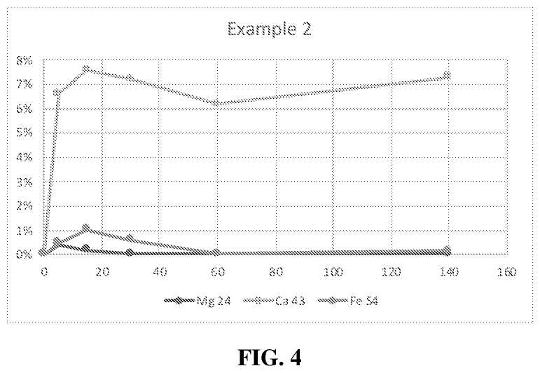

FIG. 5 shows typical ICPMS data for Example 3 solutions. Note that a logarithmic scale is used for the Y axis.

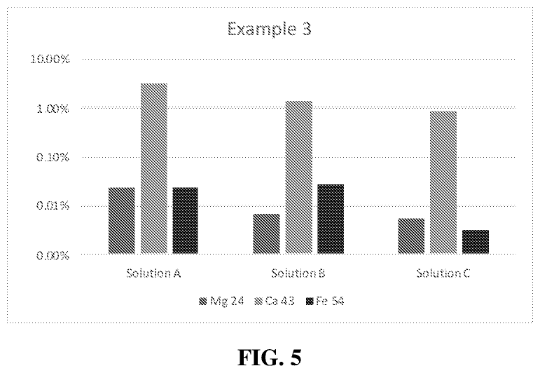

FIG. 6 shows typical ICPMS data for Example 3 solids.

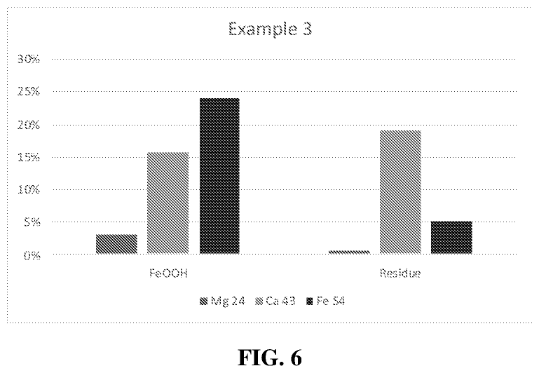

FIG. 7 shows typical ICPMS data for Example 3 solutions. Note that a logarithmic scale is used for the Y axis.

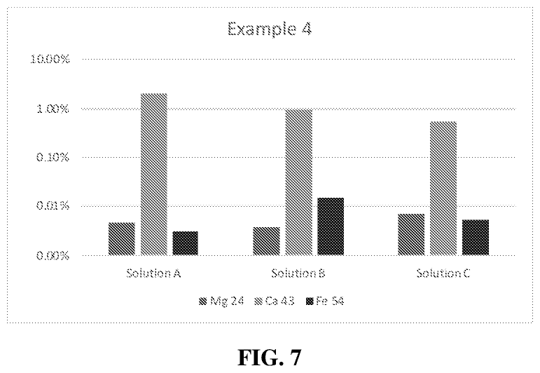

FIG. 8 shows typical ICPMS data for Example 3 solids.

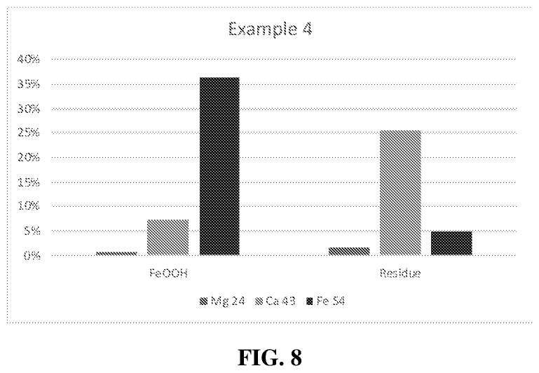

### DETAILED DESCRIPTION

The following description includes information that may be useful in understanding the present invention. It is not an admission that any of the information provided herein is prior art or relevant to the presently claimed invention, or that any publication specifically or implicitly referenced is prior art.

Compositions and methods of the inventive concept can utilize waste streams from steel manufacturing (such as spent pickle liquor and/or slag resulting from steel manufacturing) to generate high value materials. In some embodiments spent pickle liquor from steel processing can be used recover valuable alkaline earth metals (such as calcium) from low value wastes with significant calcium content in the form of insoluble oxide, hydroxides, and/or salts. Suitable raw materials include slag from steel manufacturing and ash from various operations. In other embodiments a composite material useful in removal of sulfur contaminants can be produced from steel slag by acid treatment, followed by neutralization and oxidation. Accordingly, compositions and methods of the inventive concept introduce considerable value to low value waste materials that would otherwise be discarded. In addition, compositions and methods of the inventive concept serve to reduce waste streams from industrial processes.

One should appreciate that the disclosed techniques provide many advantageous technical effects including utilizing low value materials that are normally discarded in order to generate a valuable product, while also reducing the environmental impact of steel manufacturing processes.

The following discussion provides many example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

Steel slag, bottom ash, and fly ash can all contain significant quantities of extractable calcium. This may be in multiple different forms such as oxides (CaO), hydroxides (Ca(OH)₂), or other forms (silicates, aluminates, etc.). For simplicity, the oxide form will be used in the equation examples. Similar chemistry can be inferred from this for other forms of extractable calcium.

Spent Pickle Liquor (SPL) is a low value waste stream derived from steel processing, which can be valorized through methods of the inventive concept. SPL is a solution containing large amounts of FeCl₂ (typically in the range of 5-30% by wt) and may also contain small quantities of hydrochloric acid (typically 0.5-10% by wt.). In the addition of SPL to a calcium containing source (e.g. a low value waste source such as slag or ash), there are two direct reactions that can produce desirable products in the form of extracted calcium. Equation 1 shows the reaction of aqueous ferrous chloride with calcium oxide (as part of the calcium source), to produce a valuable solution containing calcium chloride and holding insoluble ferrous hydroxide (Ksp=8×10⁻¹⁶) in suspension. Any residual hydrochloric acid in the SPL can also react with the available calcium source to produce calcium chloride in such a solution (Equation 2). Often the concentrations of the FeCl₂ and HCl in the spent pickle liquor are favorable as such to produce CaCl₂ solutions in the range of 5-30% or higher, which are of commercial and industrial interest.

FeCl_{2(aq)}+CaO₍ₛ₎+H₂O₍ₗ₎→CaCl_{2(aq)}+Fe(OH)₂₍ₛ₎
Equation 1: Reaction of ferrous chloride with calcium oxide.

2HCl_{(aq)}+CaO₍ₛ₎→CaCl_{2(aq)}+H₂O₍ₗ₎
Equation 2: Reaction of hydrochloric acid with calcium oxide.

It should be appreciated that the reaction shown in Equation 1 and/or Equation 2 require(s) only the components of the spent pickle liquor and does not require the addition of conventional lixiviant compounds. Accordingly, added lixiviant compounds can be, and are preferably, omitted from compositions and methods of the inventive concept.

Residual ferrous chloride from such reactions does not participate in any other reactions that would be undesirable. However, when HCl is present, it is possible to have some other initial reactions that produce some less desirable products. Steel slag can contain large amounts of iron in the forms of ferric oxide (Fe₂O₃), ferrous oxide (FeO), and metallic iron (Fe). All three forms may react with hydrochloric acid, as shown in Equation 3 through Equation 5. Since all three of these reactions produce FeCl₂, they do not actually present a problem provided that there is sufficient extractable calcium in the calcium source raw material, as the reaction in Equation 1 will consume the soluble iron salt and generate the desired products. The same effect can be achieved by using some of the Fe(OH)₂ or FeOOH produced by the process described herein, albeit at the cost of a slightly reduced yield.

6HCl_{(aq)}+Fe₂O₃₍ₛ₎→2FeCl_{3(ac)}+3H₂O₍ₗ₎
Equation 3: Reaction of hydrochloric acid with ferric oxide.

2HCl_{(aq)}+FeO₍ₛ₎→FeCl_{2(aq)}+H₂O₍ₗ₎
Equation 4: Reaction of hydrochloric acid with ferrous oxide.

2HCl_{(aq)}+Fe₍ₛ₎→FeCl_{2(aq)}+H_{2(g)}
Equation 5: Reaction of hydrochloric acid with metallic iron.

Steel slag and other calcium-containing materials of interest can include significant quantities of magnesium oxide (MgO). Reaction of such materials with HCl (e.g., from SPL) can occur according to Equation 6. The magnesium chloride (MgCl₂) produced therefrom can subsequently undergo reaction with available extractable calcium to generate magnesium hydroxide (Mg(OH)₂) and calcium chloride according to Equation 7. While this can provide magnesium content in the CaCl₂ solution product, it can introduce some magnesium hydroxide into the Fe(OH)₂ solid product. It should be appreciated that residual HCl can potentially extract other undesirable species from the calcium-containing material such and manganese, aluminum (as aluminates), and silicon (as silicates). Surprisingly, the Inventors have found that typical bottom ash does not appear to have this issue, and magnesium contamination on processing of steel slag is very minimal. Use of SPL with sufficiently low HCl composition (e.g. less than 10%, less than 5%, less than 1%) can minimize the extraction of unwanted metals.

In some embodiments the SPL can be treated with metallic iron, which can be magnetically separated from other components within steel slag, such that any residual HCl will be nominally consumed via Equation 5, generating additional FeCl₂. In this manner, undesired impurities will not be extracted from a calcium-containing material undergoing extraction with an SPL so treated. Hydrogen generated in such an SPL pretreatment step is also a valuable product.

2HCl_{(aq)}+MgO₍ₛ₎→MgCl_{2(aq)}+H₂O₍ₗ₎
Equation 6: Reaction of hydrochloric acid with magnesium oxide.

In some embodiments temperature of an extraction process utilizing treated or untreated SPL and calcium-containing raw materials can be controlled in order to reduce extraction of magnesium and/or silicates.

Similarly, MgCl₂ can be used to generate CaCl₂ solutions and Mg(OH)₂ from reaction with calcium-containing materials like bottom ash and steel slag. In this case, the reaction shown in Equation 7 drives the process.

MgCl_{2(aq)}+CaO₍ₛ₎+H₂O₍ₗ₎→CaCl_{2(aq)}+Mg(OH)₂₍ₛ₎
Equation 7: Reaction of magnesium chloride with calcium oxide.

In the above descriptions, the products include a soluble calcium salt solution, as well as insoluble solids; Fe(OH)₂ when using SPL as the extracting agent and Mg(OH)₂ when using MgCl₂ as the extracting agent. The solution is easily separated from the solids by simple filtration, centrifugation, settling, decanting, etc. The solid products (e.g. precipitates) generated by methods of the inventive concept tend to be very fine and suspend in water easily. The calcium-containing raw material and extracted residue produced by treatment with SPL of MgCl₂ tend to be more granular and settle more quickly. Since these solid products typically demonstrate large differences in density and/or settling speed they are relatively simple to separate from one another. Therefore, relatively pure solid products (iron or magnesium hydroxide) can be obtained by methods to separate materials with large differences in density, size, and/or hydrodynamic properties. These methods include, but are not limited to, spiral separation, centrifugation (e.g. with a cyclone separator), settling, and/or decantation.

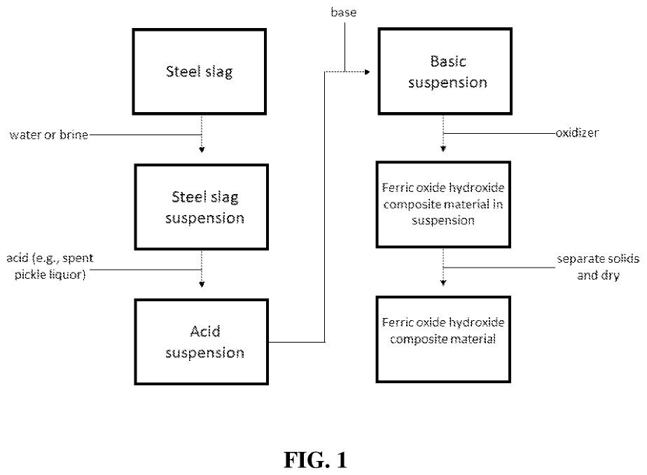

Another embodiment of the inventive concept is a composite material prepared from steel slag or similar waste. An example of a method for generating such a composite material is shown in FIG. 1. As shown, such a composite materials can be generated by adding slag produced by a steel manufacturing process to water or brine, then lowering the pH of the resulting suspension to a pH about 2 of less (e.g., 2, 1.5, 1, 0.5, or 0). The pH of the suspension can be lowered by addition of an acid, such as hydrochloric, sulfuric, phosphoric, and/or nitric acid (or materials including such acidic species). For example, spent pickle liquor containing residual HCl can be used to reduce the pH of a suspension of steel slag in water or brine to less than 2. The resulting acidic suspension is mixed (e.g., by stirring) at this low pH for a period of time ranging from 2 hours to 8 hours, preferably about 4 hours.

Following acid treatment, pH of the acidic suspension of acid-treated slag is adjusted by the addition of a base to a pH of about 9 to about 12. In preferred embodiments the pH is adjusted to about 10.5. The resulting basic suspension is mixed (e.g., by stirring) at this pH for from about 30 minutes to about 2 hours. In preferred embodiments the basic suspension is mixed for about 1 hour following the addition of base. Suitable bases include but are not limited to carbonate-containing materials such lime, hydrated lime, etc.).

Following base treatment, the basic suspension is treated with an oxidizer to generate a ferric oxide hydroxide composite material. Such an oxidizer can be a gas, such as air or another oxygen-containing gas, and can be introduced into the basic suspension by any suitable method (e.g. vigorous stirring, tumbling, sparging, etc.). Alternatively, such an oxidizer can be liquid or solid, such as a peroxide compound (e.g., hydrogen peroxide). In some embodiments two or more oxidizers can be used. Oxidizer treatment can continue for any period of time suitable to generate the ferric oxide hydroxide composite material, which is in turn dependent upon the oxidizer(s) used, the amount used, and the method of application. Typically, the ferric oxide hydroxide composite material is produced within about one hour following application of the oxidizer.

The resulting ferric oxide hydroxide composite material can be separated from the liquid portion of the suspension by any suitable means. For example, the solid ferric oxide hydroxide composite material can be separated from the aqueous phase by settling, decantation, centrifugation, filtering, etc. Following separation, the ferric oxide hydroxide composite material can be dried, for example by heating to about 50° C. to about 100° C. In preferred embodiments the ferric oxide hydroxide composite material is dried at about 75° C. Typical ferric oxide hydroxide composites results from such a process can include from 1% to 3% by mass aluminum, from 2% to 10% by mass calcium, from 20% to 30% by mass iron, from 3% to 7% by mass magnesium, and from 40% to 60% oxygen when steel slag us utilized as a starting material. Such elements can be represented by a mixture of salts, oxides, and/or hydroxides in the composite material. Results of elemental analysis of two lots of ferric oxide hydroxide composite produced in this fashion are provided in Tables 1 and 2.

TABLE 1

| Component | Result | Unit |
|---|---|---|
| Ag | 0.0016 | mass % |
| Al | 2.225 | mass % |
| As | ND | mass % |
| Au | ND | mass % |
| Ba | 0.004 | mass % |
| Bi | ND | mass % |
| Br | 0.00055 | mass % |
| Ca | 8.16 | mass % |
| Cd | 0.00165 | mass % |
| Ce | ND | mass % |
| Cl | 3.815 | mass % |
| Co | 0.0282 | mass % |
| Cr | 0.03 | mass % |
| Cs | ND | mass % |
| Cu | 0.0073 | mass % |
| Dy | ND | mass % |
| Er | ND | mass % |
| Eu | ND | mass % |
| Fe | 22.5 | mass % |
| Ga | ND | mass % |
| Gd | ND | mass % |
| Ge | ND | mass % |
| Hf | ND | mass % |
| Hg | ND | mass % |
| Ho | ND | mass % |
| I | ND | mass % |
| In | ND | mass % |
| Ir | ND | mass % |
| K | ND | mass % |
| La | ND | mass % |
| Lu | ND | mass % |
| Mg | 4.57 | mass % |
| Mn | 0.3415 | mass % |
| Mo | ND | mass % |
| Na | ND | mass % |
| Nb | ND | mass % |
| Nd | ND | mass % |
| Ni | 0.02825 | mass % |
| O | 48.75 | mass % |
| Os | ND | mass % |
| P | ND | mass % |
| Pb | ND | mass % |
| Pd | 0.0003 | mass % |
| Pm | ND | mass % |
| Po | ND | mass % |
| Pr | ND | mass % |
| Pt | ND | mass % |
| Rb | 0.00225 | mass % |
| Re | 0.0021 | mass % |
| Rh | ND | mass % |
| Ru | ND | mass % |
| S | 1.01 | mass % |
| Sb | ND | mass % |
| Sc | ND | mass % |
| Se | ND | mass % |
| Si | 8.15 | mass % |
| Sm | ND | mass % |
| Sn | ND | mass % |
| Sr | 0.00305 | mass % |
| Ta | ND | mass % |
| Tb | ND | mass % |
| Tc | ND | mass % |
| Te | ND | mass % |
| Ti | 0.2805 | mass % |
| Tl | ND | mass % |
| Tm | ND | mass % |
| V | 0.01605 | mass % |
| W | 0.07 | mass % |
| Y | 0.0023 | mass % |
| Yb | ND | mass % |
| Zn | 0.00355 | mass % |

TABLE 2

| Component | Result | Unit |
|---|---|---|
| Ag | 0.00125 | mass % |
| Al | 2.815 | mass % |
| As | 0.00125 | mass % |
| Au | ND | mass % |
| Ba | 0.01565 | mass % |
| Bi | ND | mass % |
| Br | ND | mass % |
| Ca | 3.75 | mass % |
| Cd | 0.0009 | mass % |
| Ce | ND | mass % |
| Cl | 0.8415 | mass % |
| Co | 0.03515 | mass % |
| Cr | 0.03475 | mass % |
| Cs | ND | mass % |
| Cu | 0.0084 | mass % |
| Dy | ND | mass % |
| Er | ND | mass % |
| Eu | ND | mass % |
| Fe | 26.75 | mass % |
| Ga | ND | mass % |
| Gd | ND | mass % |
| Ge | ND | mass % |
| Hf | ND | mass % |
| Hg | 0.0007 | mass % |
| Ho | ND | mass % |
| I | ND | mass % |
| In | ND | mass % |
| Ir | ND | mass % |
| K | ND | mass % |
| La | ND | mass % |
| Lu | ND | mass % |
| Mg | 5.845 | mass % |
| Mn | 0.4125 | mass % |
| Mo | 0.0003 | mass % |
| Na | ND | mass % |
| Nb | 0.0025 | mass % |
| Nd | ND | mass % |
| Ni | 0.02875 | mass % |
| O | 48 | mass % |
| Os | ND | mass % |
| P | ND | mass % |
| Pb | ND | mass % |
| Pd | ND | mass % |
| Pm | ND | mass % |
| Po | ND | mass % |
| Pr | ND | mass % |
| Pt | ND | mass % |
| Rb | 0.00405 | mass % |
| Re | ND | mass % |
| Rh | ND | mass % |
| Ru | ND | mass % |
| S | 0.4785 | mass % |
| Sb | ND | mass % |
| Sc | ND | mass % |
| Se | ND | mass % |
| Si | 10.5 | mass % |
| Sm | ND | mass % |
| Sn | ND | mass % |
| Sr | 0.0058 | mass % |
| Ta | ND | mass % |
| Tb | ND | mass % |
| Tc | ND | mass % |
| Te | ND | mass % |
| Ti | 0.355 | mass % |
| Tl | ND | mass % |
| Tm | ND | mass % |
| V | 0.0232 | mass % |
| W | ND | mass % |
| Y | 0.00345 | mass % |
| Yb | ND | mass % |
| Zn | 0.00435 | mass % |

The resulting ferric oxide hydroxide composite material is a particulate material, with an average particle size ranging from 10 μm to 10 mm. In some embodiments the ferric oxide hydroxide composite material can be re-sized following separation from the aqueous phase used in the oxidation step in order to accommodate the desired application. This can be accomplished by, for example, grinding or milling until the desired size range is reached. Ferric oxide hydroxide composite materials of the inventive concept can be used as is (e.g., as a particulate bed or suspension) , or can be used in combination with a carrier (e.g., as a part of a particle-coated fiber or sheet).

Ferric oxide hydroxide composite materials of the inventive concept can be used in sulfur and/or heavy metal contamination removal processes with a variety of materials. For example, ferric oxide hydroxide composite materials produced as described above can be used to remove sulfur or a sulfur-containing compound from natural gas, natural gas liquids, biogas, landfill gas, acid gas, geothermal gas, tank vent gas, coke oven gas, oilfield associated gas, or any gas or liquid contaminated with sulfur or sulfur-containing compounds. Similarly, such ferric oxide hydroxide composite materials can be used to remove metals such as arsenic, selenium, and heavy metals from liquid and gaseous materials, and suspensions of metal-contaminated solids.

Removal of sulfur, sulfur compounds, and/or undesired metals can be accomplished by contacting the contaminated material with a ferric oxide hydroxide composite material of the inventive concept for a period of time sufficient for the sulfur, sulfur-containing compound, and/or metal to complex with the ferric oxide hydroxide composite material. Contact can be provided in any suitable reactor. For example, a ferric oxide hydroxide composite material of the inventive concept can be provided as a bed of particulate or granular material through which a flow of the contaminated material is directed. Alternatively, particles of a ferric oxide hydroxide composite material of the inventive concept can be provided on a fiber, mat, or web support through which the material to be treated is passed. In still other embodiments, the ferric oxide hydroxide composite material can be provided as a bolus of particulates that are suspended in a gas or liquid to be treated, and subsequently removed. In some embodiments ferric oxide hydroxide composite material recovered from such operations can be further processed to recover materials removed from a treated gas or liquid (e.g., heavy metals), which can be present in commercially valuable concentrations in such spent ferric oxide hydroxide composite material.

### EXAMPLE 1

300 g of spent pickle liquor (21.7% FeCl₂, 1.7% HCl by weight) was stirred at 800 RPM in a 500 ml beaker. 154 g of bottom ash was added. The temperature of the reaction mixture was found to increase. Small aliquots of the solution were taken periodically to monitor the progress of the reaction. These aliquots were filtered through a small bed of Celite to ensure that only the solution phase was saved. The mixture thickened considerably after about 8 minutes of reaction time. The color of the mixture also began to turn dark green, consistent with the formation of Fe(OH)₂ solids. Within about 30 minutes of reaction time, the mixture began to lose viscosity. After 140 minutes of reaction time, the mixture was allowed to stand briefly (a few minutes) during which some solids settled, and other smaller particles did not. Size separation was done by decanting the solution, followed by transferring the smaller particles into a Buchner funnel with filter paper under vacuum. These solids were washed with water and dried at 105° C. to constant weight. A second “light” solids fraction was obtained by resuspending remaining solids in water and isolating the slow-settling material by filtration. This solids fraction was further washed and also dried at 105° C. to constant weight. Similarly, two fractions of heavier, faster settling materials were obtained and dried.

Analysis of the solution fractions by ICPMS shows that the iron concentration in solution dropped as the calcium concentration increased with reaction time ( [symbol] ). Analysis of the solid fractions are summarized in [symbol] . This data supports the notion that the lighter fractions are more concentrated in iron oxides/hydroxides and the heavier fractions contain more calcium.

### EXAMPLE 2

132 g of concentrated HCl (32.2% HCl by weight) was stirred at 700 RPM in a 500 ml beaker. 154 g of bottom ash was added. The reaction mixture was found to get very hot and to boil for a brief time. Small aliquots of the solution were taken periodically to monitor the progress of the reaction. These aliquots were filtered through a small bed of Celite to ensure that only the solution phase was saved. Early reaction time samples were a faint yellow in color. Later samples were colorless. After 140 minutes of reaction time, the mixture was filtered through a Buchner funnel with filter paper, under vacuum. The solids were washed with water and dried at 110° C. to constant weight. A small sample (14.191 g) of the final solution was evaporated at 110° C. to a constant weight of 3.883 g. The white residue obtained was believed to be the dihydrate of calcium chloride. Based on this inference, the solution obtained was by weight CaCl₂.

Analysis of the solution fractions by ICPMS shows that the calcium levels quickly reach their maximum and that while there is initially a small amount of iron in solution, it drops with time ( [symbol] ).

### EXAMPLE 3

25 g of bed ash, sieved to 2,000-4,750 micron range was added to 18 g of spent pickle liquor (21.7% FeCl₂, 1.7% HCl by weight) in a polypropylene 50 ml centrifuge tube. The mixture was capped and shaken briefly. The temperature of the mixture increased markedly. The reaction mixture and was allowed to react overnight. 10 g of water was added, and the mixture gently shaken again to resuspend fine particles. The suspension was decanted into a Buchner funnel with filter paper under vacuum. This first fraction (A) weighed 4.94 g, and was clear and colorless. Another 15 g of water was added to the reaction tube and then the mixture gently shaken. Decanting this through the same filter paper and funnel afforded 15.71 g clear colorless solution as a separate fraction (B). A third rinse fraction (C) was obtained in the same manner using an additional 15 g water, yielding 14.95 g solution. The fine particles collected in the Buchner funnel were dark green in color. The larger particles left behind in the centrifuge tube were also dark green in them, suggesting retention of some of the ferrous hydroxide on the extracted bed ash residue. Both solids fractions were dried at 110° C. to constant weights of 0.6686 g and 30.38 g respectively. Solutions A through C were subjected to loss on drying to determine CaCl₂ content. These were 10.43% CaCl₂ (A), 4.95% CaCl₂ (B), and 2.81% CaCl₂ (C). ICPMS analysis was consistent with these values and showed very minimal Mg and Fe impurities ( [symbol] ). ICPMS analysis of the solids fractions showed significantly higher iron content in the fine FeOOH fraction than the extracted bed ash residue ( [symbol] ).

### EXAMPLE 4

17.5 g of bed ash, sieved to 500-2,000 micron range was added to 10 g of spent pickle liquor (21.7% FeCl₂, 1.7% HCl by weight) and 20 g water in a polypropylene 50 ml centrifuge tube. The mixture was capped and shaken briefly. The temperature of the mixture increased markedly. The reaction mixture was allowed to react overnight. The suspension was decanted into a Buchner funnel with filter paper under vacuum. This first fraction (A) weighed 12.26 g and was clear and colorless. Another 15 g of water was added to the reaction tube and then the mixture gently shaken. Decanting this through the same filter paper and funnel afforded 16.56 g of clear colorless solution as a separate fraction (B). A third rinse fraction (C) was obtained in the same manner using an additional 15 g water, yielding 15.60 g solution. The fine particles collected in the Buchner funnel were dark green in color. The larger particles left behind in the centrifuge tube were also dark green, suggesting that some of the ferrous hydroxide adheres to the extracted bed ash residue. Both solids fractions were dried at 110° C. to constant weight of 0.3626 g and 11.90 g respectively. Solutions A through C were subjected to loss on drying to determine CaCl₂ content. These were 7.34% CaCl₂ (A), 3.25% CaCl₂ (B), and 1.51% CaCl₂ (C). ICPMS analysis was consistent these values and showed very minimal Mg and Fe impurities ( [symbol] ). ICPMS analysis of the solids fractions showed significantly higher iron loading in the fine FeOOH fraction than the extracted bed ash residue ( [symbol] ).

### EXAMPLE 5

Three hundred (300) mLs per minute of a gas containing 1% CO₂ by volume and 2,000 ppm H₂S, with the balance being N₂, was passed through a water bubbler and then a column containing 2.5 grams of composite ferric oxide hydroxide composite material prepared from iron slag as described above. The time to breakthrough of the gas (defined as reaching 100 ppm H₂S in the exiting gas stream) was determined to be 516 minutes.

### EXAMPLE 6

Three hundred (300) mLs per minute of a gas containing 1% CO₂ by volume and 2,000 ppm H₂S, with the balance being N₂, was passed through a water bubbler and then a column containing 2.5 grams of composite ferric oxide hydroxide composite material prepared from iron slag as described above. The time to breakthrough of the gas (defined as reaching 100 ppm H₂S in the exiting gas stream) was determined to be 493 minutes.

### EXAMPLE 7

Three hundred (300) mLs per minute of a gas containing 1% CO₂ by volume and 2,000 ppm H₂S, with the balance being N₂, was passed through a water bubbler and then a column containing 2.5 grams of composite ferric oxide hydroxide composite material prepared from iron slag as described above. The time to breakthrough of the gas (defined as reaching 100 ppm H₂S in the exiting gas stream) was determined to be 443 minutes.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

What is claimed is:

1-22. (canceled)

23. A method for extracting calcium from a solid source material, comprising:
obtaining a spent pickle liquor; and
contacting the solid source material with the spent pickle liquor in the absence of an added lixiviant to generate an aqueous solution comprising Ca(Cl)₂, a solid comprising Fe(OH)₂, and an extracted source material.

24. The method of claim 23, comprising contacting the spent pickle liquor with metallic iron prior to contacting the solid source material.

25. The method of claim 23, wherein the solid source material is a steel slag or an ash.

26. The method of claim 23, wherein HCl content of the spent pickle liquor is less than about 10% by weight.

27. The method of claim 23, comprising separating the aqueous solution from the solid comprising Fe(OH)₂ and from the extracted source material.

28. The method of claim 27, comprising separating the solid containing Fe(OH)₂ from the extracted source material.

29. The method of claim 23, comprising processing the extracted source material to extract an additional metal.

30. A method of preparing a composite material, comprising:
suspending a slag in an aqueous medium to form a slag suspension;
adjusting pH of the slag suspension to 2 or less to form an acid suspension and mixing for from 2 to 8 hours;
adjusting pH of the acid suspension to between 9 to 12 to form a basic suspension and mixing for from 30 minutes to 2 hours; and
oxidizing by adding an oxidant to the basic suspension and mixing to generate a composite material comprising ferric oxide hydroxide.

31. The method of claim 30, wherein the slag is a slag byproduct of steel manufacturing.

32. The method of claim 30, wherein adjusting pH to form the acid suspension is performed by addition of spent pickle liquor.

33. The method of claim 30, wherein adjusting pH to form the basic suspension is performed by addition of a carbonate-containing material.

34. The method of claim 33, wherein the carbonate-containing material is lime.

35. The method of claim 30, wherein the oxidizer comprises an oxygen-containing gas.

36. The method of claim 35, wherein the oxygen-containing gas is air.

37. The method of claim 30, wherein the oxidizer comprises a peroxide.

38. The method of claim 30, further comprising:
following, oxidation, separating the composite from remaining liquid phase to generate a particulate solid comprising the composite; and
drying the particulate solid.

39. A method of removing sulfur or a sulfur-containing compound from a fluid, comprising contacting the fluid with a ferric oxide hydroxide composite material of claim 18 for a period of time sufficient for sulfur or the sulfur-containing compound to complex with the ferric oxide hydroxide composite material.

40. The method of claim 39, wherein the fluid is selected from the group consisting of natural gas, natural gas liquids, biogas, landfill gas, acid gas, geothermal gas, tank vent gas, coke oven gas, and oilfield associated gas.

41. A method of removing a metal from a material contaminated with the metal, comprising contacting the material with a ferric oxide hydroxide composite material of claim 18 for a period of time sufficient for the metal to complex with the ferric oxide hydroxide composite material.

42. The method of claim 41, wherein the metal is selected from the group consisting of arsenic, selenium, and a heavy metal.
